(19) United States
(12) Patent Application Publication
(10) Pub. No.: US 2022/0404515 A1
(43) Pub. Date: Dec. 22, 2022

(54) SYSTEMS AND METHODS FOR MAPPING SEISMIC DATA TO RESERVOIR PROPERTIES FOR RESERVOIR MODELING

(71) Applicant: ConocoPhillips Company, Houston, TX (US)

(72) Inventors: Christopher S. Olsen, Houston, TX (US); Douglas Hakkarinen, Houston, TX (US); Michal Brhlik, Houston, TX (US); Upendra K. Tiwari, Houston, TX (US); Timothy D. Osborne, Houston, TX (US); Nickolas Paladino, Houston, TX (US); Mark A. Wardrop, Houston, TX (US); David W. Glover, Houston, TX (US); Brock Johnson, Houston, TX (US); Peter Bormann, Houston, TX (US); Charles Ildstad, Houston, TX (US)

(21) Appl. No.: 17/842,304

(22) Filed: Jun. 16, 2022

Related U.S. Application Data
(60) Provisional application No. 63/222,822, filed on Jul. 16, 2021.
(60) Provisional application No. 63/211,447, filed on Jun. 16, 2021.

(51) Int. Cl. G01V 1/28; G01V 1/30; G06N 3/08; G01V 1/36

(52) U.S. Cl. CPC G01V 1/282; G01V 1/306; G06N 3/08; G01V 1/36

(57) ABSTRACT

Implementations described and claimed herein provide systems and methods for reservoir modeling. In one implementation, an input dataset comprising seismic data is received for a particular subsurface reservoir. Based on the input dataset and utilizing a deep learning computing technique, a plurality of trained reservoir models may be generated based on training data and/or validation information to model the particular subsurface reservoir. From the plurality of trained reservoir models, an optimized reservoir model may be selected based on a comparison of each of the plurality of reservoir models to a dataset of measured subsurface characteristics.

### CROSS-REFERENCE TO RELATED APPLICATIONS

The present application claims priority to U.S. Provisional Patent Application No. 63/222,822, entitled “Systems and Methods for Mapping Seismic Data to Reservoir Properties for Reservoir Modeling” and filed on Jul. 16, 2021, and U.S. Provisional Patent Application No. 63/211,447, entitled “Systems and Methods for Mapping Seismic Data to Reservoir Properties for Reservoir Modeling” and filed on Jun. 16, 2021. Each of these applications is specifically incorporated by reference in its entirety herein.

### FIELD

Aspects of the present disclosure relate generally to systems and methods for developing models of reservoirs and, more particularly, to mapping seismic data directly to reservoir properties for reservoir modeling utilizing deep learning and computer vision techniques.

### BACKGROUND

Reservoir modeling is used in all manner of scientific and technological fields, from geology to the oil and gas industry, to gain an understanding of subsurface characterizations and structures. In general, reservoir modeling involves the generation of computer models of subsurface reservoirs, such as petroleum reservoirs, to aid in development of the reservoir management scenarios. Reservoir model generation may include well log data that provides high vertical resolution but is sparsely measured across a field and seismic with good spatial resolution but poor vertical detail. Traditionally, the different data sets are combines for a more complete subsurface picture through a seismic inversion process of converting the seismic to the elastic domain using a sensitive assumption of a velocity model, and then converting the elastic domain into the reservoir properties used to generate the reservoir model. However, this process is often time consuming, highly iterative, and heavily reliant on the underlying rock physics model parameterization and calibration. It is with these observations in mind, among others, that various aspects of the present disclosure were conceived and developed.

### SUMMARY

Implementations described and claimed herein address the foregoing problems by providing systems and methods for reservoir modeling. In one implementation, an input dataset comprising seismic data is received for a particular subsurface reservoir. Based on the input dataset and utilizing a deep learning computing technique, a plurality of trained reservoir models may be generated based on training data and/or validation information to model the particular subsurface reservoir. From the plurality of trained reservoir models, an optimized reservoir model may be selected based on a comparison of each of the plurality of reservoir models to a dataset of measured subsurface characteristics.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows an example network environment that may implement various systems and methods discussed herein.

FIG. 2 is a block diagram illustrating example data flow for generating a reservoir model utilizing deep thinking and/or computer vision techniques.

FIG. 3 illustrates example operations for generating a reservoir model.

FIG. 4 shows an example block diagram of a reservoir model generation system for mapping seismic data directly to reservoir properties for reservoir modeling.

FIG. 5 illustrates an example screenshot of a reservoir model generation tool listing loaded generated reservoir models.

FIG. 6 illustrates an example screenshot of the reservoir model generation tool listing executed generated reservoir models.

FIG. 7 illustrates an example screenshot of the reservoir model generation tool listing reservoir model performance metrics over time.

FIG. 8 illustrates an example screenshot of the reservoir model generation tool listing training parameters for training the generation of reservoir models.

FIG. 9 illustrates an example screenshot of the reservoir model generation tool utilizing a generated reservoir model to predict reservoir development.

FIG. 10 shows an example computing system that may implement various systems and methods discussed herein.

### DETAILED DESCRIPTION

Aspects of the present disclosure involve systems and methods for reservoir modeling utilizing 3D computer vision or other deep thinking computational techniques to reduce the processing time necessary for generating the model. In one particular implementation, the systems and methods may utilize 3D computer vision or other deep thinking computational techniques to combine the steps of converting seismic data to the elastic domain then converting the elastic domain into the reservoir properties for generating a reservoir model into a single step. Such techniques and systems allow for the direct mapping of any set of seismic datasets directly to the measured reservoir properties from which the reservoir model may be generated. Such reservoir properties may be from well log measurements or subject matter expert interpretations. The methods and system described herein provide for mapping to the reservoir properties with greater accuracy and precision than it can for a single seismic trace on both classification and regression-based tasks. The result is a faster, more accurate, data driven seismic data to reservoir properties workflow that carries less interpretation bias. A user-oriented tool is also presented for interacting with the reservoir modeling systems and methods to generate an optimized reservoir model to predict reservoir development. Other advantages will be apparent from the present disclosure.

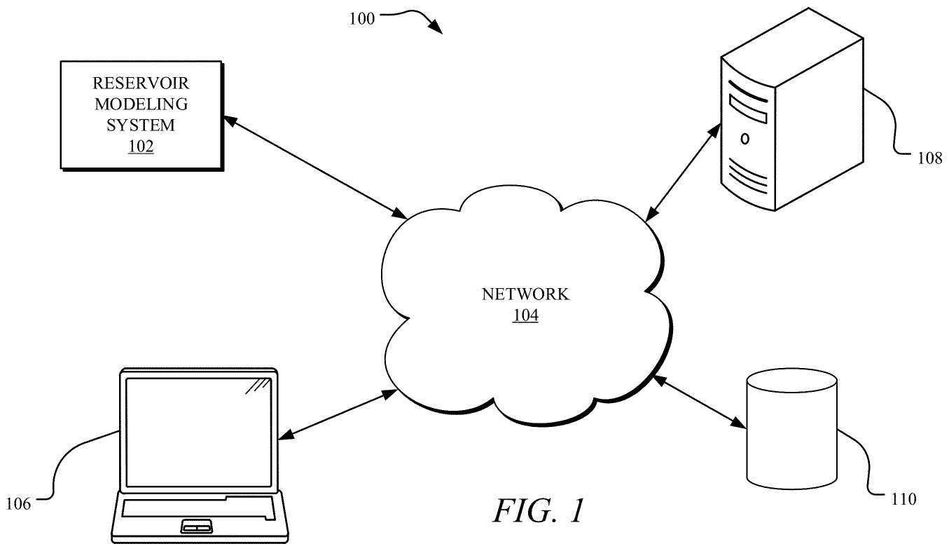

To begin a detailed discussion of an example asset development system 100, reference is made to FIG. 1. FIG. 1 illustrates an example network environment 100 for implementing the various systems and methods, as described herein. As depicted in FIG. 1, a network 104 is used by one or more computing or data storage devices for implementing the systems and methods for generating one or more reservoir models using the reservoir modeling system 102. In one implementation, various components of the reservoir modeling system 102, one or more user devices 106, one or more databases 110, and/or other network components or computing devices described herein are communicatively connected to the network 104. Examples of the user devices 106 include a terminal, personal computer, a smartphone, a tablet, a mobile computer, a workstation, and/or the like.

A server 108 may, in some instances, host the system. In one implementation, the server 108 also hosts a website or an application that users may visit to access the network environment 100, including the reservoir modeling system 102. The server 108 may be one single server, a plurality of servers with each such server being a physical server or a virtual machine, or a collection of both physical servers and virtual machines. In another implementation, a cloud hosts one or more components of the system. The reservoir modeling system 102, the user devices 106, the server 108, and other resources connected to the network 104 may access one or more additional servers for access to one or more websites, applications, web services interfaces, etc. that are used for reservoir modeling.

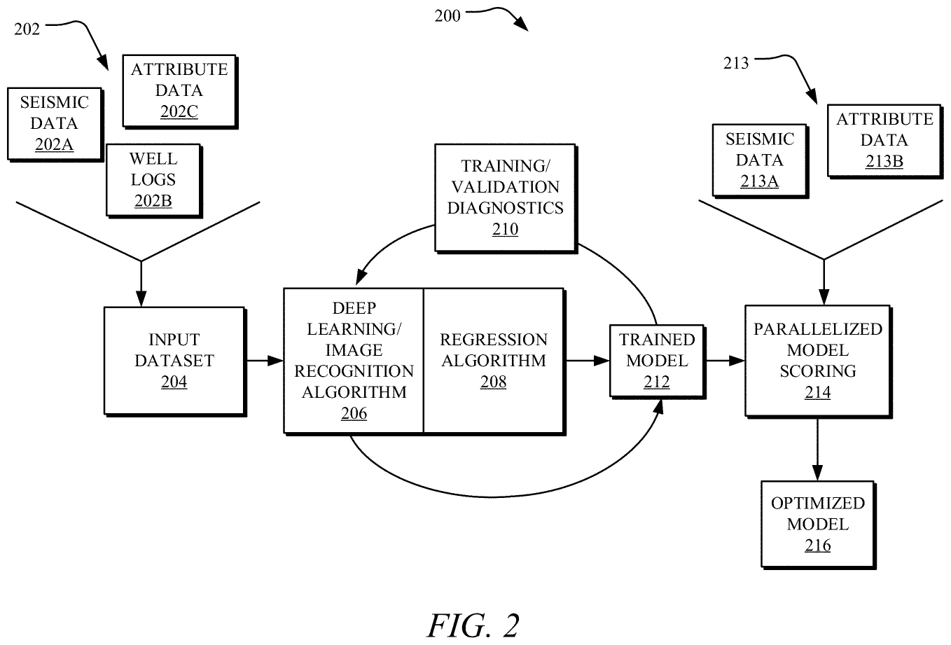

FIG. 2 is a block diagram illustrating an example data flow for the reservoir modeling system 102 to generate a reservoir model utilizing deep thinking and/or computer vision techniques. Through the data flow 200 of FIG. 2, a reservoir model may be generated without the need to convert seismic data into an elastic domain and then from the elastic domain to reservoir parameters to generate the model. Rather, machine learning, artificial intelligence, image recognition, and other algorithms or techniques may be trained through an iterative validation process to map seismic data to reservoir parameters for a faster and more accurate reservoir model generation. In one particular implementation, the steps outlined in the data flow 200 of FIG. 2 may be executed by the reservoir modeling system 102 automatically or in response to inputs provided through a user interface to generate an optimized reservoir model. In other instances, however, any component of the network environment 100 may execute one or more applications as described in relation to the data flow 200 of FIG. 2.

The data flow 200 may include generating an input dataset 204 for input to a deep learning system 206. The dataset 204 may include any reservoir associated data, such as but not limited to, seismic data 202A, well logs 202B, and petrophysical or other rock property data, rock property models, and/or flow simulation information (collectively referred to herein as “attribute data” 202C). As mentioned above, seismic data 202A may be obtained through any known or hereafter developed seismic-based measurement techniques for determining subsurface characteristics. Well logs 202B may be obtained through, among other techniques, analysis of a well-drilled core sample to determine the geological make-up of the well. Attribute data 202C may be obtained from any known or hereafter developed physical model of rock characteristics, measurements, simulations, and the like. The number and types of data 202 included in the input dataset 204 may vary from model to model such that no particular type of data 202 is required to generate the reservoir model. Rather, any datasets may be supplied as input to the deep learning machine 206, although additional data may result in a more detailed reservoir model provided by the reservoir modeling system 102.

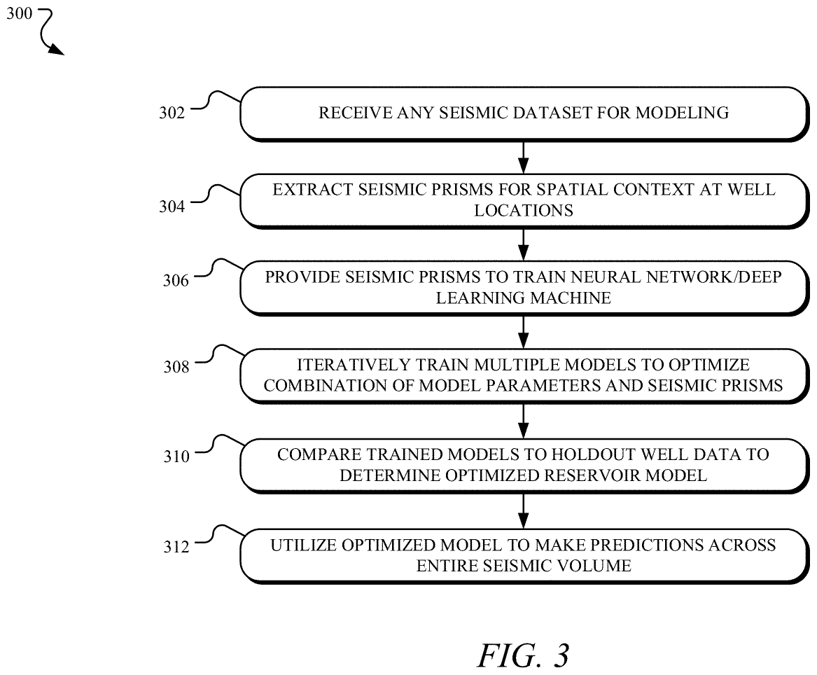

The collection of reservoir-based data 202 may be combined into an input dataset 204 for use by the deep learning machine or technique 206. In one particular implementation, the deep learning technique 206 may utilize aspects of image recognition techniques to generate a baseline reservoir model for analysis. In particular, the deep learning machine 206 may execute one or more of the operations illustrated in the flowchart of FIG. 3. In particular, FIG. 3 illustrates example operations for generating a reservoir model. The operations may be performed by a computing device configured to execute any machine learning or artificial intelligent algorithm, including image recognition techniques. Such operations may be executed through control of one or more hardware components, one or more software programs, or a combination of both hardware and software components of the computing device.

Beginning in operation 302, the computing device may receive any seismic or reservoir-based dataset 204 for inclusion in modeling a reservoir. As explained above, such a dataset 204 may include data obtained through seismic analysis 202A, well logs 202B, attribute data 202C, or any other reservoir modeling-related data. The data 202 may be obtained from as many stacks as an operator desires, including fault probability data, far angle stack data, mid angle stack data, and/or near angle stack data. In operation 304, the computing device may extract one or more seismic prisms from the seismic dataset 204 at log or interpretation locations to generate spatial context to the well locations. In one particular implementation, the extracted prisms may be three-dimensional prisms at particular interpretation well locations. In another example, the input dataset 204 may represent a volume, such as a continuous 3D/4D volume, where the volume may be represented with changes over time. In some instances, two different volumes may be incorporated to characterize the reservoir either in overlapping volumes or in a joined volume. In operation 306, the extracted 3D prisms or 3D/4D volumes are providing to a neural network or other deep learning machine 206. In one particular example, a label or target value of the input dataset 204 may be provided to the deep learning machine 206. The labels or target values may be specific values for a volume location—such as a data point from a well (production or exploratory), a microseismic event, a known feature (salt dome, fracture, void, reservoir, oil, gas, etc), and the like. Well data may include hydrocarbon content, well log data, resistivity, porosity, rock type, fracture location, wellbore location, produced fluid, gas-oil-ratio, production rates, geochemical markers, core sample information, etc. Any data that may be attached to a location in the volume may be used as a label or target value of the input dataset 204. Such data labeling and target values may apply to various geophysics areas in geobody identification, with any interpretation data labels being obtained by geoscience methods, including but not limited to, Distributed Acoustic Sensing (DAS), Distributed Temperature Sensing (DTS), Neutron, Gamma, NMR, porosity, flow, temperature, pressure, depth, total depth, bottom hole pressure, bottom hole temperature, hydrocarbon content, water content, gas content, microseismic events, fracture direction, drained reservoir volume, and/or the like. The labels and/or target values may be specific values for a volume location—such as a data point from a well (production or exploratory), a microseismic event, a known feature (salt dome, fracture, void, reservoir, oil, gas, etc.), and the like. In one example, the operation 306 obtains input datasets to specify a geobody to the tool as specified by a polygon area that is of a classification of interest are provided in the space of the target volume.

In operation 308, the deep learning machine 206 may iteratively train multiple models, based on the provided dataset 204, to determine a combination of model parameters to the seismic prisms. For example, the deep learning machine 206 may utilize one or more image recognition algorithms to correlate the seismic prisms with various generated reservoir models and, through a regression algorithm 208, may train/validate the various generated models with the input dataset 204. In one implementation, training/validation diagnostics 210 may be applied to each generated reservoir model to determine an accuracy of the model to the input datasets 204. Through a determined error obtained from the application of the various reservoir models to the training/validation diagnostics 210, the deep learning machine 206 may determine how accurate or how closely the generated model corresponds to the input dataset 204. The deep learning machine 206 may then alter the generated reservoir model based on the determined error to address and attempt to eliminate the error. This process of model generation, regression, validation, and alteration may be repeated until the determined error of the reservoir model (as based on the validation diagnostics 210) falls below a threshold value. In another example, the deep learning machine 206 or a user of the deep learning machine may pick a subset of “training inputs” and “validation inputs” based on labels, targets, prioritized areas and the like. There is no fixed or set method for number of inputs for training and number of validations. Distributed inputs and validation provide better results and prevents either trained model or validation from being biased to one feature or section of the data. Training and validation data may be changed manually or iteratively to further improve models and remove bias. One or more parameters of the deep learning machine 206 may also be adjusted to improve a trained model 212. Such parameters to adjust the deep learning machine 206 may include the size of the volume of the input dataset 204, the size of the data, type of data, model behavior, volumes, data location, target and validation classification, number of iterations, updates and chunks, range, volume multipliers, cube z, vertical context, and the like. In this manner, the deep learning machine 206 may utilize techniques (such as one or more image recognition algorithms) to generate or alter reservoir models that are trained, through the above-described iterative process, to accurately represent the dataset 204.

Through the operations above, the deep learning machine 206 may generate multiple reservoir models that each perform within the thresholds of the validation diagnostics. However, some reservoir models generated by the deep learning machine 206 may be more accurate than others. To determine the optimal model generated by the system, each trained model 212 may be applied to a parallel model scoring 214 technique in operation 310. In particular, each trained model 212 may be compared to data 213 from one or more holdout wells to determine an accuracy score for the generated trained models 212. Such holdout well data 213 may include, but is not limited to, seismic data 213A and/or attribute data 213B associated with the holdout wells. To compare the trained model 212 to the holdout well data 213, a simulation may be executed on each trained model 212 to determine an expected dataset for the holdout wells and a comparison of the expected dataset to the actual datasets 213A, 213B may be performed at the parallelized model scoring 214 of the system. The trained model 212 with the lowest delta between the expected dataset values and the measured dataset values at the holdout wells may be considered the optimized reservoir model 216. This optimized model 216 may, in operation 312, be utilized to make predictions of the reservoir properties across the entire seismic volume for the reservoir being modeled.

In another example, the model validation may compare validation inputs to a “model” and gives an error, typically a lower error means a better model. The distribution of training data and validation data improves results and reduces the error, although the error may not ever reach zero. In one particular example, initial models may have an error of 0.8 while a well refined model may have an error of 0.3. The reservoir modeling system 102 may select a “Best Model” (M_{Best}) or a user may pick a M_{Best} based on features or other factors.

In one particular implementation, the overall data flow process 200 described above with relation to FIGS. 2 and 3 may be distributed across a High Performance Cluster (HPC) of computing devices. For example, the various trained models 212 generated by the iterative process may be scored in parallel through a distribution of the trained models onto various computing machines of the HPC. In this manner, the simulations executed on the trained models and the accuracy scores of the various models may be obtained simultaneously to reduce the time needed to complete the model evaluations. In a similar manner, multiple computing devices may execute the deep learning/image recognition techniques in a parallel manner to generate the multiple trained models 212 for the reservoir associated with the dataset 204 simultaneously such that the trained models 212 may be generated at a faster rate than previous implementations that may generate the trained models serially.

It should be noted that the data flow 200 and method 300 discussed above may generate a reservoir model without converting the dataset 204 first into the elastic domain and from the elastic domain to reservoir properties. Rather, the systems and methods may generate multiple potential trained reservoir models 212 and analyze each model to determine which of the generated models most closely resembles the reservoir being modeled. This may remove the dependency on underlying rock physics model parameterization and calibration, increasing the accuracy of the generated reservoir model through the reduction of interpretation bias in the synthesis process to identify reservoir structures, drill wells in better locations with better drained volumes, and improve production.

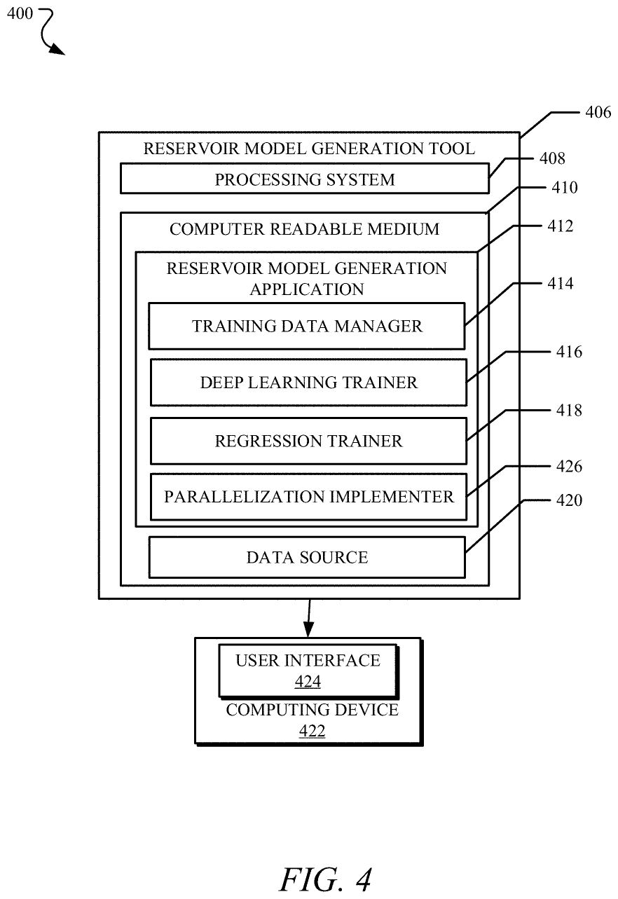

FIG. 4 shows an example block diagram of a reservoir model generation system 400 for mapping seismic data directly to reservoir properties for reservoir modeling. In general, the system 400 may include a reservoir model generation system 406. In one implementation, the reservoir model generation tool 406 may be a part of the reservoir modeling system 102 of FIG. 1. As shown in FIG. 4, the reservoir model generation tool 406 may be in communication with a computing device 422 providing a user interface 424. As explained in more detail below, the reservoir model generation tool 406 may be accessible to various users to generate a reservoir model based on datasets 204 provided to the tool by the user. Access to the reservoir model generation tool 406 may occur through the user interface 424 executed on the computing device 422.

As explained above, the reservoir model generation tool 406 may generate an optimized reservoir model 216 based on a dataset 204. Thus, the reservoir model generation tool 406 may include a reservoir model generation application 412 executed to perform one or more of the operations described herein. The reservoir model generation application 412 may be stored in a computer readable media 410 (e.g., memory) and executed on a processing system 408 of the reservoir model generation tool 406 or other type of computing system, such as that described below. For example, the reservoir model generation application 412 may include instructions that may be executed in an operating system environment, such as a Microsoft Windows™ operating system, a Linux operating system, or a UNIX operating system environment. The computer readable medium 410 includes volatile media, nonvolatile media, removable media, non-removable media, and/or another available medium. By way of example and not limitation, non-transitory computer readable medium 410 comprises computer storage media, such as non-transient storage memory, volatile media, nonvolatile media, removable media, and/or non-removable media implemented in a method or technology for storage of information, such as computer readable instructions, data structures, program modules, or other data.

The reservoir model generation application 412 may also utilize a data source 420 of the computer readable media 410 for storage of data and information associated with the reservoir model generation tool 406. For example, the reservoir model generation application 412 may store information associated with iterations of the generated reservoir models, training/validation diagnostic information or data, trained reservoir models 212, model accuracy scoring, and the like. As described in more detail below, various generated models may be stored and used via the user interface 424 to simulate or otherwise determine reservoir performance or conditions such that trained or optimized reservoir models for various reservoirs may be stored in the data source 420.

The reservoir model generation application 412 may include several components to perform one or more of the operations described herein. For example, reservoir model generation application 412 may include a training data manager 414 to manage the input dataset 204 to the deep learning machine 206 for generating one or more reservoir models based on the input dataset. The training data manager 414 may, in some instances, receive various types of data 202, such as seismic data 202A, well logs 202B, attribute data 202C, and/or other types of reservoir-related data and combine the data into an input dataset 204 for use in generating a reservoir model. Further, the training data manager 414 may also manage training/validation diagnostic information and data 210 used in determining an accuracy of a generated reservoir model to the input dataset 204. For example, the training data manager 414 may compare simulated results on a generated reservoir model and determine a difference between the simulated results and the input dataset 204 to determine an accuracy of the generated model. Past results of the training of the model may also be stored and/or maintained by the training data manager 414 for comparison to current results to determine if the generated model is becoming more accurate or less accurate in response to the machine training. In general, any information or data provided as inputs to the deep learning machine 206 and/or utilized to train or validate a generated reservoir model may be managed by the training data manager 414.

The reservoir model generation application 412 may also include a deep learning trainer 416 and regression trainer 418 to generate and/or train one or more reservoir models based on an input dataset 204 received from the training data manager 414. As explained above, the deep learning trainer 416 may include any machine learning or artificial intelligence techniques to generate a reservoir model from the input dataset 204. In one particular implementation, the deep learning trainer 416 may employ a neural network (e.g., a neural model, such as A U-NET style architecture) to execute an image recognition algorithm on the dataset 204 to generate one or more reservoir models from the input dataset 204. The regression trainer 418 may reduce the complexity of the generated reservoir models and apply the models to the training/validation diagnostics 210 for iterative training. Together, the deep learning trainer 416 and the regression trainer 418 may develop a plurality of trained models of the reservoir associated with the input dataset 204.

A parallelization implementer 426 may also be included and executed by the reservoir model generation application 412. In general, the parallelization implementer 426 may manage the parallelization of the training of the generated reservoir models and/or the model scoring on the HPC. For example, the parallelization implementer 426 may provide the generated models to one or more computing devices of the HPC for training, simulation, and comparing to the diagnostic data. Similarly, the parallelization implementer 426 may communicate with the one or more computing devices of the HPC to apply measured data 213 to the trained models 212 to determine an accuracy of the trained models. In general, any communication between the reservoir model generation application 412 and the HPC may be managed by the parallelization implementer 426 to reduce the time to generate an optimized reservoir model 216 for simulation of reservoir characteristics and development.

It should be appreciated that the components described herein are provided only as examples, and that the application 412 may have different components, additional components, or fewer components than those described herein. For example, one or more components as described in FIG. 4 may be combined into a single component. As another example, certain components described herein may be encoded on, and executed on other computing systems.

Several advantages over previous ways to generating a reservoir model may be gained through the methods and systems described herein. For example, the reservoir modeling system 102 may facilitate data loading, pre-processing, transformation and alignment to the well log data, a dynamic and flexible model construction process, and data handling, generation, augmentation during model training. Other advantages include automated techniques for model validation, automated capture of model training results, and automated implementation of model hyper-parameter optimization to repeatedly train new models in a search for the optimal model configuration. The described modeling framework also streamlines user access to Graphical Processing Unit (GPU) resources in the HPC to improve model training speed and a visualization and data framework allows users to track model optimization. The model prediction framework may also distribute the prediction tasks out to as many computational resources as desired in order to speed up the process while automatically taking care of the hardware resourcing, setup, and take-down tasks. Still other advantages include an efficient process that makes it easy for users to connect their data to the modeling tools while receiving the results a short time later while avoiding complex rock physics calibration steps, and inverts observations directly to reservoir properties (such as porosity, Facies, saturation changes and pressure changes) in the reservoir and reducing interpretation bias common in previous reservoir model generation systems.

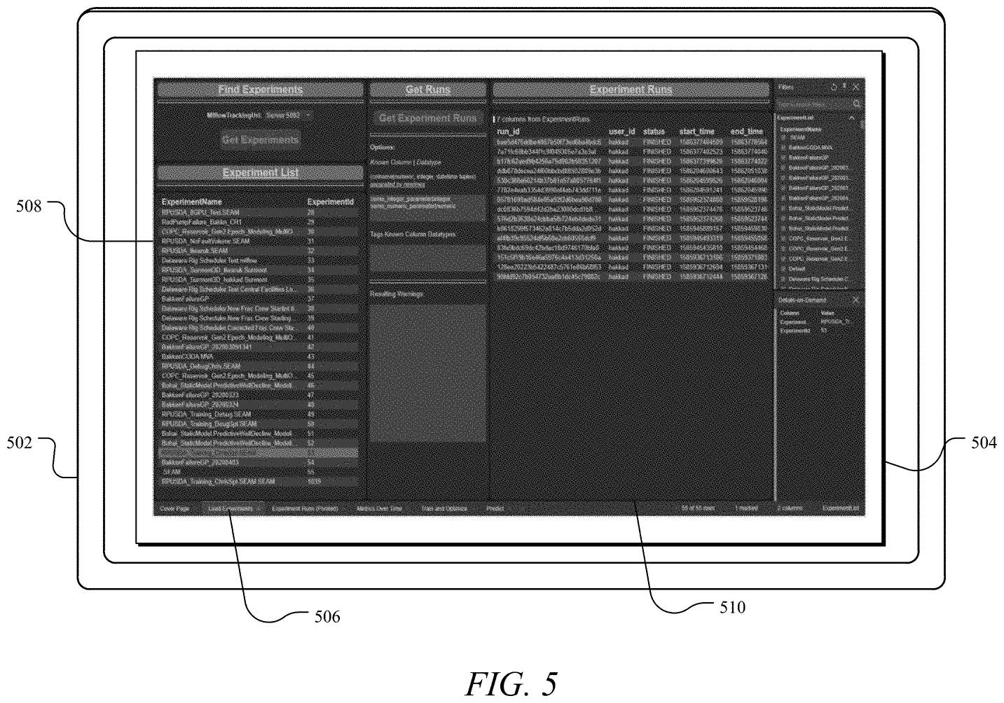

As mentioned, the reservoir model generation tool 406 may communicate with a user interface 424 executed on a computing device 422 to provide access to the tool for users of the computing device. FIGS. 5-9 illustrate example screenshots of a user interface for interacting with the reservoir model generation tool listing 406. Through the user interface 424, input datasets 204 may be provided to the tool, trained models 212 may be analyzed and processed, and/or optimized reservoir models 216 may be accessed to simulate future reservoir developments or characteristics for planning purposes.

FIG. 5 illustrates an example screenshot 500 of a user interface 504 to the reservoir model generation tool through which a user may connect to the tool and view available reservoir model training sets. In particular, a user may select, via a user input to a computing device 502, tab 506 to access a listing of the available reservoir model training sets. A list of available training sets, or “experiments”, may be listed in a first window panel 508 of the user interface 500 and a listing of completed experiments for each of the listed experiments may be listed in a second window panel 510 of the interface. Upon selection of a training set in the first panel 506, the results of the recent executions of the experiments may be illustrated in the second panel 510. As such, the user interface 504 may provide access to previously run model training sets for alteration of existing reservoir models with new datasets.

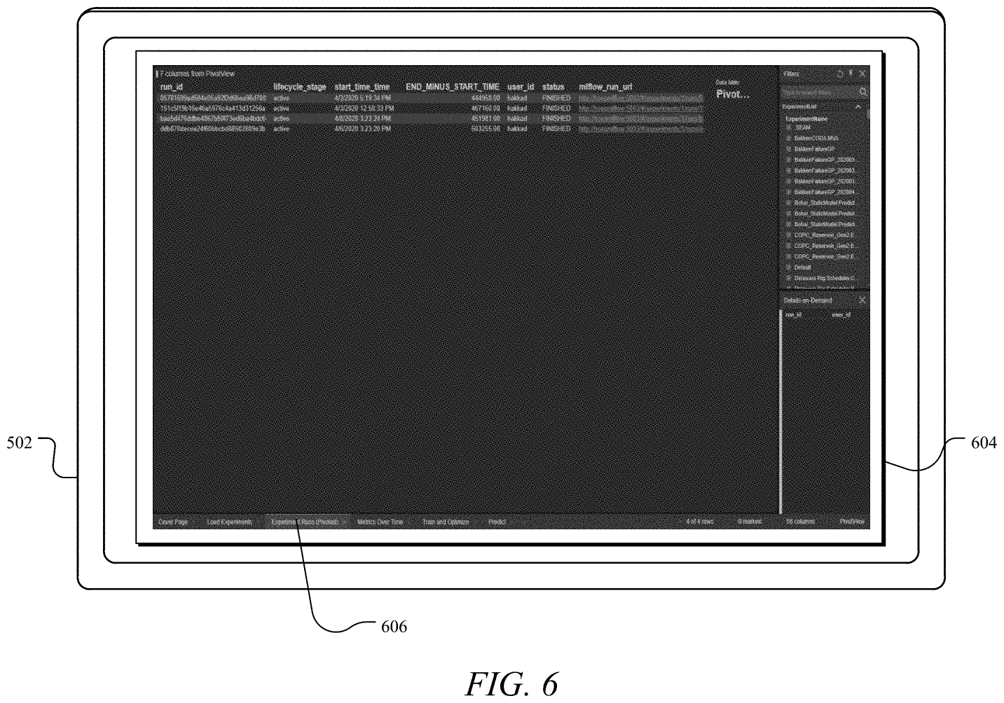

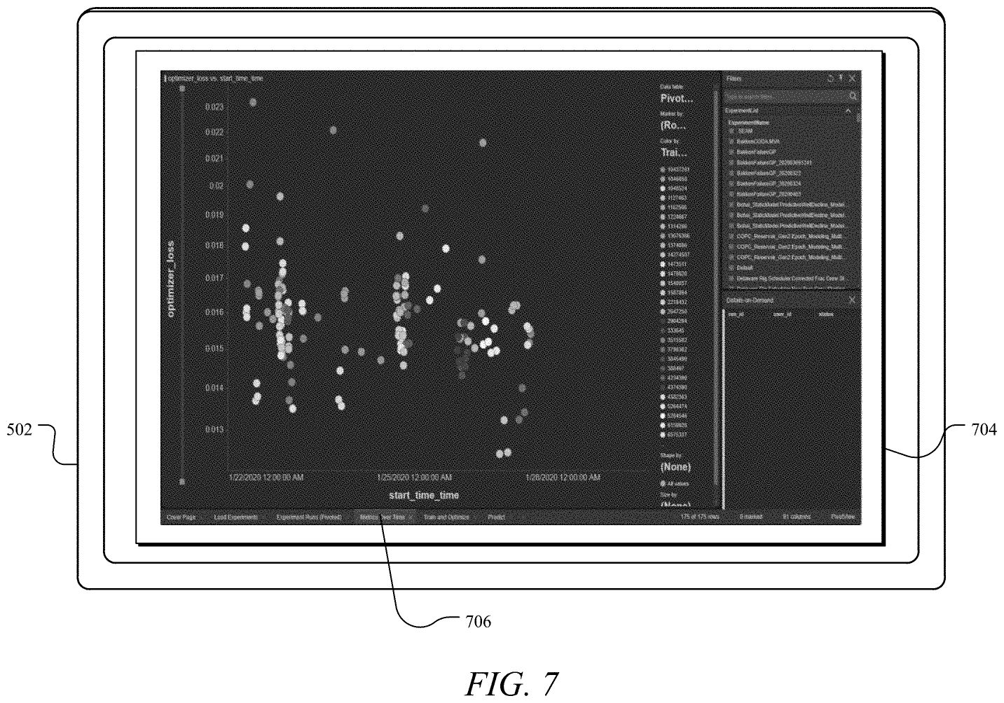

FIG. 6 illustrates an example screenshot 600 of a user interface 604 to the reservoir model generation tool through which a user may populate a structured table of logged parameters and metrics involved in the project's training run. In particular, for a selected experiment, a user may select tab 606 via the user interface 604. Upon selection, the training runs for the selected experiment may be expanded to provide additional data or results of the selected training run. FIG. 7 illustrates an example screenshot 700 of a user interface 704 to the reservoir model generation tool through which performance metrics of the training sets over time are graphed. In particular, for a selected experiment, a user may select tab 706 via the user interface 704. Upon selection, a graph illustrating a difference between a trained model 212 and the expected dataset (obtained at the parallelized model scoring 214 step) versus time is illustrated. The graph may provide a user of the interface 704 an indication of when the trained model achieved peak optimization such that additional training runs on the dataset 204 may be stopped. The graph may therefore provide a user with an indication that optimization of a trained model 214 is complete, further reducing the time to model generation.

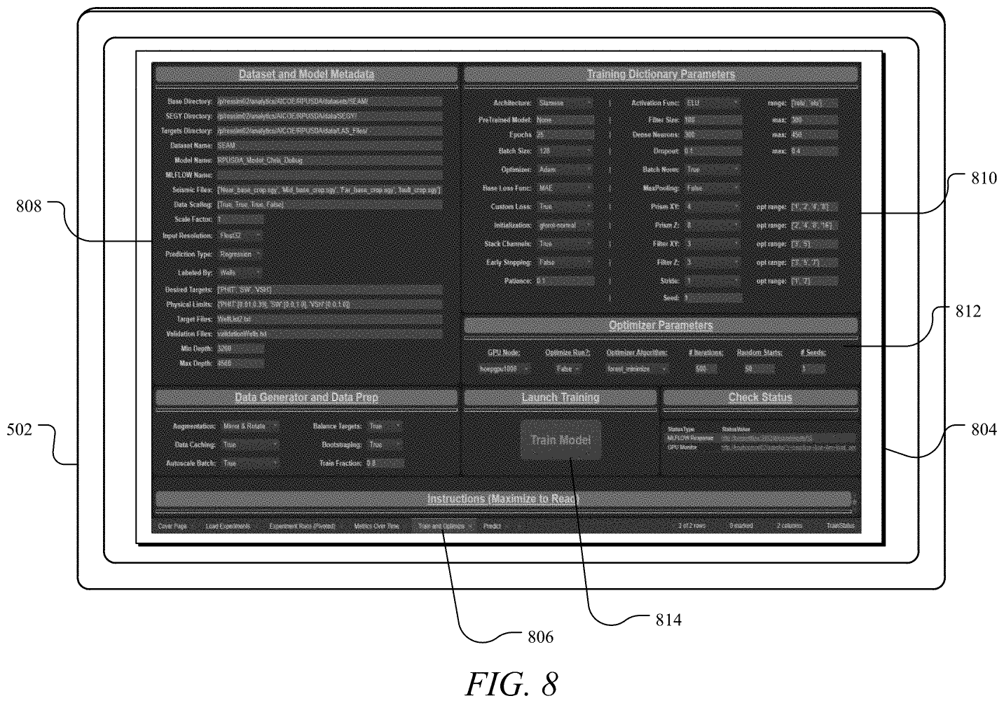

FIG. 8 illustrates an example screenshot 800 of a user interface 804 to the reservoir model generation tool through which a user may adjust the input parameters used to train the reservoir models 212 and the determine an optimized model 216. In particular, a user may select tab 806 via the user interface 804. Upon selection of the tab 806, the user interface 804 may display various panels or areas within the interface for providing or adjusting input datasets and/or training and optimizing parameters. In a first panel 808, the input dataset 204 may be defined or identified to the reservoir model generation tool 406. Identification of the input dataset 204 may include input of a storage location of the data to be included in the dataset. The first panel 808 may also include one or more fields to define metadata or parameters for generation of the reservoir model. For example, a scaling factor, a prediction type for the model, storage location of validation data, a model name or other identifier, and the like may be input to the reservoir model generation tool 406 via the first panel 808 of the user interface 804. A second panel 810 may also be displayed that provides one or more input fields for defining the training parameters for training of the reservoir models. In general, any machine learning parameter may be displayed and adjusted through the second panel 810, based on the machine learning and regression techniques employed by the reservoir model generation tool 406 to generate the reservoir models. In one particular implementation, one or more of the training parameters may be associated with a pull-down menu interface for adjusting the parameters within a predefined number of available options for the corresponding parameter.

In a similar manner, a third panel 812 of the user interface 804 may provide one or more input fields for defining optimization parameters associated with the parallelized model scoring 214 of the reservoir model generation tool 406. For example, the optimization parameters of the third panel 812 may include, but are not limited to, an identification of a Graphics Processing Unit (GPU) node for processing the optimization, identification of an algorithm to conduct the optimization from a collection of available optimization algorithms, a number of iterations to optimize, and the like. In general, any optimization parameter may be displayed and adjusted through the third panel 812, based on the optimization techniques employed by the reservoir model generation tool 406 to optimize the generated reservoir models.

In some instances, one or more of the inputs variables displayed in the user interface 804 may be a default value determined by the reservoir model generation tool 406. Thus, a user of the user interface 804 may not need to adjust or otherwise provide inputs on the training or optimizing parameters. Rather, based on the selected dataset, the reservoir model generation tool 406 may populate one or more of the parameters for reservoir model generation. Reservoir model generation may therefore occur without adjustments to the parameters by the user. To begin the process of reservoir model generation, a “train model” button 814 may also be provided in the user interface 804. The selection of the start button 814 by a user via an input device to the computing device 502 may initiate the reservoir model generation processes discussed above.

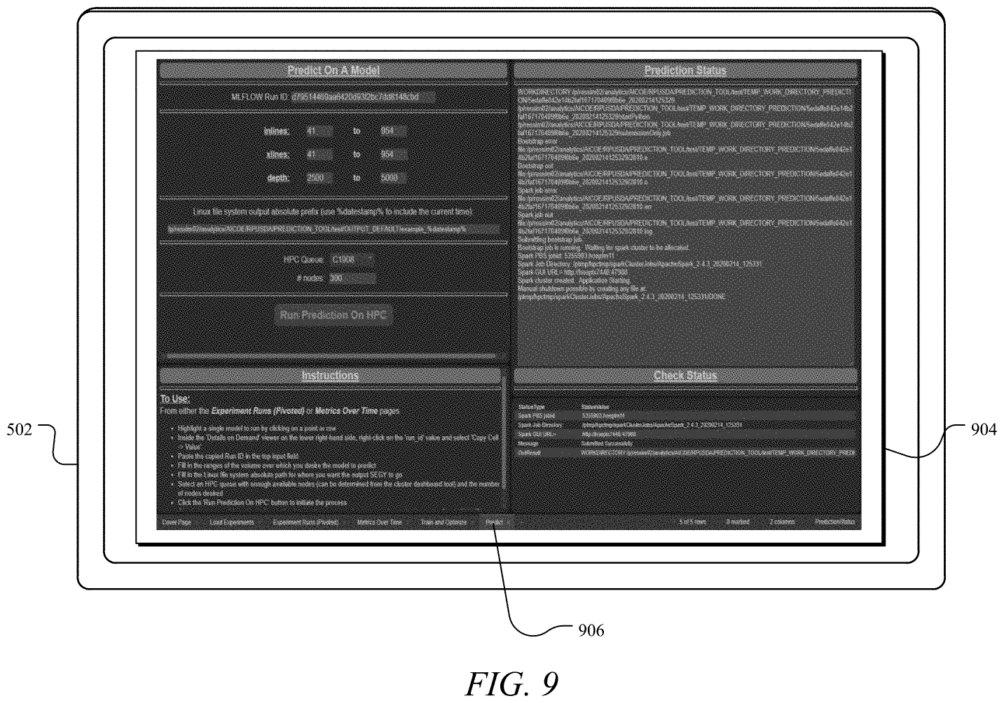

FIG. 9 illustrates an example screenshot 900 of a user interface 904 to the reservoir model generation tool through which a user may run a prediction of reservoir characteristics on a reservoir model. In particular, a user may select tab 906 via the user interface 904. Upon selection of the tab 906, the user interface 904 may display various panels within the interface for initiating a prediction on a reservoir model. Various inputs may be provided via the user interface 904 to control the prediction (such as an identification of a trained reservoir model, a link or pathname to a reservoir model file, one or more desired seismic boundaries to run the computation over, and/or an output location for the prediction results) and results or statuses of the executed prediction may be displayed. In one particular implementation, the prediction may be executed on the HPC to reduce the time to completion for the prediction.

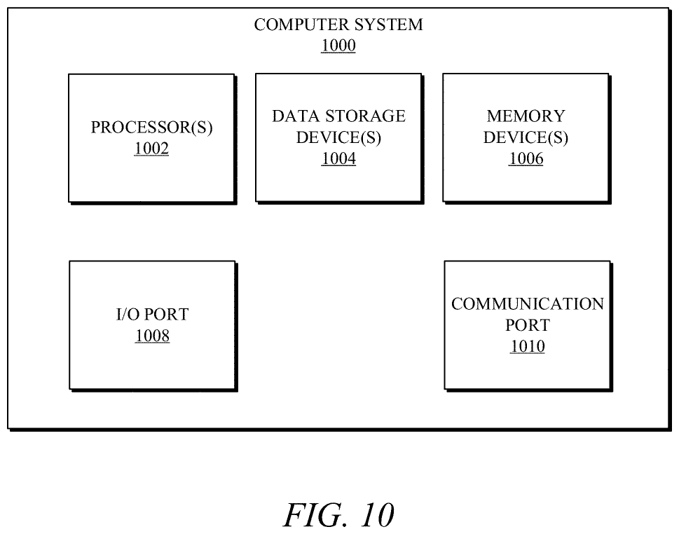

Referring to FIG. 10, a detailed description of an example computing system 1000 having one or more computing units that may implement various systems and methods discussed herein is provided. The computing system 1000 may be applicable to the reservoir modeling system 102, the system 100, and other computing or network devices. It will be appreciated that specific implementations of these devices may be of differing possible specific computing architectures not all of which are specifically discussed herein but will be understood by those of ordinary skill in the art.

The computer system 1000 may be a computing system is capable of executing a computer program product to execute a computer process. Data and program files may be input to the computer system 1000, which reads the files and executes the programs therein. Some of the elements of the computer system 1000 are shown in FIG. 10, including one or more hardware processors 1002, one or more data storage devices 1004, one or more memory devices 1008, and/or one or more ports 1008-1010. Additionally, other elements that will be recognized by those skilled in the art may be included in the computing system 1000 but are not explicitly depicted in FIG. 10 or discussed further herein. Various elements of the computer system 1000 may communicate with one another by way of one or more communication buses, point-to-point communication paths, or other communication means not explicitly depicted in FIG. 10.

The processor 1002 may include, for example, a central processing unit (CPU), a microprocessor, a microcontroller, a digital signal processor (DSP), and/or one or more internal levels of cache. There may be one or more processors 1002, such that the processor 1002 comprises a single central-processing unit, or a plurality of processing units capable of executing instructions and performing operations in parallel with each other, commonly referred to as a parallel processing environment.

The computer system 1000 may be a conventional computer, a distributed computer, or any other type of computer, such as one or more external computers made available via a cloud computing architecture. The presently described technology is optionally implemented in software stored on the data stored device(s) 1004, stored on the memory device(s) 1006, and/or communicated via one or more of the ports 1008-1010, thereby transforming the computer system 1000 in FIG. 10 to a special purpose machine for implementing the operations described herein. Examples of the computer system 1000 include personal computers, terminals, workstations, mobile phones, tablets, laptops, personal computers, multimedia consoles, gaming consoles, set top boxes, and the like.

The one or more data storage devices 1004 may include any non-volatile data storage device capable of storing data generated or employed within the computing system 1000, such as computer executable instructions for performing a computer process, which may include instructions of both application programs and an operating system (OS) that manages the various components of the computing system 1000. The data storage devices 1004 may include, without limitation, magnetic disk drives, optical disk drives, solid state drives (SSDs), flash drives, and the like. The data storage devices 1004 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 1006 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 1004 and/or the memory devices 1006, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 1000 includes one or more ports, such as an input/output (I/O) port 1008 and a communication port 1010, for communicating with other computing, network, or reservoir development devices. It will be appreciated that the ports 1008-1010 may be combined or separate and that more or fewer ports may be included in the computer system 1000.

The I/O port 1008 may be connected to an I/O device, or other device, by which information is input to or output from the computing system 1000. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 1000 via the I/O port 1008. Similarly, the output devices may convert electrical signals received from computing system 1000 via the I/O port 1008 into signals that may be sensed as output by a human, such as sound, light, and/or touch. The input device may be an alphanumeric input device, including alphanumeric and other keys for communicating information and/or command selections to the processor 1002 via the I/O port 1008. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 1000 via the I/O port 1008. For example, an electrical signal generated within the computing system 1000 may be converted to another type of signal, and/or vice-versa. In one implementation, the environment transducer devices sense characteristics or aspects of an environment local to or remote from the computing device 1000, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 1000, such as, physical movement of some object (e.g., a mechanical actuator), heating or cooling of a substance, adding a chemical substance, and/or the like.

In one implementation, a communication port 1010 is connected to a network by way of which the computer system 1000 may receive network data useful in executing the methods and systems set out herein as well as transmitting information and network configuration changes determined thereby. Stated differently, the communication port 1010 connects the computer system 1000 to one or more communication interface devices configured to transmit and/or receive information between the computing system 1000 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 1010 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G) network), or over another communication means. Further, the communication port 1010 may communicate with an antenna or other link for electromagnetic signal transmission and/or reception.

In an example implementation, reservoir model data, and software and other modules and services may be embodied by instructions stored on the data storage devices 1004 and/or the memory devices 1006 and executed by the processor 1002. The computer system 1000 may be integrated with or otherwise form part of the air filtration system 104.

The system set forth in FIG. 10 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for generating a model of a subsurface reservoir, the method comprising:
generating an input dataset comprising seismic data associated with a subsurface reservoir;
training, based on the input dataset and utilizing a deep learning computing technique, a plurality of reservoir models; and
selecting, based on a comparison of each of the plurality of reservoir models to a dataset of measured subsurface characteristic, an optimized reservoir model from the plurality of trained reservoir models.

2. The method of claim 1 wherein the deep learning computing technique comprises a three-dimensional image recognition technique.

3. The method of any of claims 1-2, further comprising:
extracting, from the input dataset, three-dimensional seismic prisms from the seismic data; and
providing the extracted three-dimensional seismic prisms as an input to the deep learning computing technique.

4. The method of any of claims 1-3, further comprising:
iteratively train the plurality of reservoir models by, for each of the plurality of reservoir models: generating, based on a corresponding reservoir model, an expected dataset; and
generating, based on a comparison of the expected dataset to the input dataset, a model error value.

5. The method of any of claims 1-4, further comprising:
transmitting the plurality of reservoir models to a high performance cluster of computing devices for training the plurality of reservoir models utilizing the deep learning computing technique.

6. The method of any of claims 1-5 wherein the input dataset comprises seismic data obtained from at least one of a far angle stack, a mid-angle stack, or a near angle stack.

7. The method of any of claims 1-6 further comprising:
generating, based on the optimized reservoir model, a predicted subsurface reservoir characteristic.

8. The method of any of claims 1-7 further comprising:
displaying, on a user interface, a performance metric of the plurality of reservoir models.

9. The method of claim 8 further comprising:
receiving, via the user interface, a storage location of the input dataset.

10. The method of any of claims 8-9 further comprising:
receiving, via the user interface, at least one of a training parameter, an optimizing parameter, or a prediction parameter.

11. One or more tangible non-transitory computer-readable storage media storing computer-executable instructions for performing a computer process on a computing system, the computer process comprising the method of any of claims 1-10.

12. A system adapted to carry out the method of any of claims 1-10, the system comprising:
a reservoir modeling system including the deep learning computing technique trained using the training data, the reservoir modeling system receiving the input dataset and generating the optimized reservoir model.
